(19) United States
(12) Patent Application Publication
(10) Pub. No.: US 2012/0260062 A1
(43) Pub. Date: Oct. 11, 2012

(54) SYSTEM AND METHOD FOR PROVIDING DYNAMIC ADDRESSABILITY OF DATA ELEMENTS IN A REGISTER FILE WITH SUBWORD PARALLELISM

(75) Inventors: Jeffrey H. Derby, Chapel Hill, NC (US); Robert K. Montoye, Rocheter, MN (US)

(73) Assignee: INTERNATIONAL BUSINESS MACHINES CORPORATION, Armonk, NY (US)

(21) Appl. No.: 13/081,635

(22) Filed: Apr. 7, 2011

(51) Int. Cl. G06F 15/76; G06F 9/06

(52) U.S. Cl. 712/4; 712/E09.003

(57) ABSTRACT

A method and system for providing dynamic addressability of data elements in a vector register file with subword parallelism. The method includes the steps of: determining a plurality of data elements required for an instruction; storing an address for each of the data elements into a pointer register where the addresses are stored as a number of offsets from the vector register file's origin; reading the addresses from the pointer register; extracting the data elements located at the addresses from the vector register file; and placing the data elements in a subword slot of the vector register file so that the data elements are located on a single vector within the vector register file; where at least one of the steps is carried out using a computer device so that data elements in a vector register file with subword parallelism are dynamically addressable.

### BACKGROUND OF THE INVENTION

The present invention relates to register files and, more particularly, to managing data elements within a register file with subword parallelism.

A register file is an array of processor registers in a central processing unit (CPU). Register files are employed by a processor or execution unit to store various data intended for manipulation.

Single Instruction Multiple Data (SIMD) architectures have been used to provide efficient processing for algorithms with data-level parallelism, however this efficiency is reduced or lost if all of the required data elements required by an instruction are not located on a single vector with the register file.

### SUMMARY OF THE INVENTION

Accordingly, one aspect of the present invention provides a method of providing dynamic addressability of data elements in a vector register file with subword parallelism. The method includes the steps of: determining a plurality of data elements required for an instruction; storing an address for each of the data elements into a pointer register where the addresses are stored as a number of offsets from the vector register file's origin; reading the addresses from the pointer register; extracting the data elements located at the addresses from the vector register file; and placing the data elements onto a single vector; where at least one of the steps is carried out using a computer device so that data elements in a vector register file with subword parallelism are dynamically addressable.

Another aspect of the present invention provides a system for providing dynamic addressability of data elements in a vector register file with subword parallelism. The system includes a determination module, where the determination module is adapted to determine the data elements required by an instruction; a storage module, where the storage module is adapted to store addresses for each of the data elements into a pointer register where the addresses are stored as a number of offsets from the vector register file's origin; a reading module, where the reading module is adapted to reading the addresses from the pointer register; an extraction module, where the extraction module is adapted to extract the data elements located at the addresses from the vector register file; and a placement module, where the placement module is adapted to place the data elements on a single vector.

### BRIEF DESCRIPTION OF THE DRAWINGS

FIG. 1 shows an example process flow of an instruction incorporating a preferred embodiment of the present invention.

FIG. 2 is a flow chart illustrating a method 200 of providing dynamic addressability of data elements in a vector register file with subword parallelism according to a preferred embodiment of the present invention.

FIG. 3 shows a system for providing dynamic addressability of data elements in a vector register file with subword parallelism according to a preferred embodiment of the present invention.

FIG. 4 is a flow chart illustrating a method 400 of providing dynamic addressability of data elements in a vector register file with subword parallelism according to another preferred embodiment of the present invention.

FIG. 5 shows an example of the architecture of a typical 32-bit VMX instruction.

### DETAILED DESCRIPTION OF THE PREFERRED EMBODIMENTS

Single Instruction Multiple Data (SIMD) architectures have been used to provide efficient processing for algorithms with data-level parallelism. Well-known examples of SIMD architectures are (1) Vector Multimedia eXtension (VMX)/Altivec extensions to the PowerPC architecture, (2) Streaming SIMD Extensions (SSE) as employed in the current x86 architecture, (3) Advanced Vector eXtentions (AVX) as proposed by Intel as an evolution of SSE and (4) eLite Digital Signal Processor (DSP) architecture that was developed in IBM Research. A SIMD machine processes “vectors” (actually “short vectors”, as distinguished from the long vectors used in true vector machines), with a vector consisting of some number of data elements of equal size which are processed in parallel in the SIMD processor. For VMX and SSE, vectors are 128 bits in length. For AVX vectors, vectors can be 256 bits in length. A 128-bit vector can contain four 32-bit fullwords. The eLite DSP had SIMD units supporting vectors of different sizes. For example, one employed 64-bit vectors which contained four 16-bit halfwords, while another employed 160-bit vectors which contained four 40-bit data elements. A word is a term for the natural unit of data used by a particular computer design. A word is simply a fixed sized group of bits that are handled together by the system. Within a Power PC architecture, a word typically refers to 32 bits of data. In addition, a halfword typically refers to 16 bits of data; and a byte typically refers to 8 bits of data.

SIMD architectures such as VMX, SSE and AVX support “subword parallelism”. With subword parallelism, data is held as vectors in vector registers with the contents of the vector register interpreted as several independent data elements to be operated on in parallel. In addition, VMX, SSE and AVX support several sizes for the data elements in a vector. The size of the data elements are determined by the instruction used to process the vector. For VMX and SSE, the register file that holds vectors is a file of 128-bit registers with one vector per register. In these systems, a 128-bit vector can be viewed by the machine as consisting of four 32-bit data elements, eight 16-bit elements, or 16 8-bit elements. AVX employs 256-bit registers with one vector per register. In AVX, a 256-bit vector can be viewed by the machine as consisting of four 64-bit data elements, eight 32-bit data elements, sixteen 16-bit data elements, or thirty two 8-bit elements. In the eLite architecture there are several register files such as a file of (1) 16-bit registers from which four 16-bit halfwords can be extracted to form a 64-bit vector and (2) 160-bit registers with one 160-bit vector per register. However, the eLite architecture employs subword parallelism for 160-bit vectors but not for 64-bit vectors.

As noted, SIMD architectures can provide significant efficiencies for algorithms with data-level parallelism. However, there are times when data elements that should be processed in parallel, start out in arbitrary registers in the register file and in arbitrary subword slots in these registers. For example, most algorithms involving the use of sparse arrays are in this category. In these cases, traditional SIMD architectures such as VMX, SSE, and AVX provide little or no parallel processing advantage since all of the data elements are not on a single vector.

The eLite architecture sought to deal with the issue by introducing (1) a SIMD execution unit with a scalar register file, namely the file of 16-bit registers noted above and (2) an indirect access mechanism to provide dynamic addressability of four registers simultaneously. This enabled the eLite architecture to select up to four 16-bit halfwords which can be combined to create the 64-bit vector for processing (see Moreno et.al., “An innovative low-power high-performance programmable signal processor for digital communications”, IBM Journal of Research and Development, Vol. 47, No 2/3, March 2003; U.S. Pat. No. 6,665,790). This eLite architecture enabled the SIMD architecture to provide significant efficiencies to an larger number of algorithms by introducing dynamic addressability of independent data elements, the addressability being managed by software, once they are in a register file.

Using the eLite architecture, several independent data elements can be addressed and extracted from the register file and then organized into a vector for SIMD processing. However, the eLite architecture achieved this objective by incorporating a mechanism to provide dynamic addressability of registers in a scalar register file. This provided dynamic addressability of registers, not of individual data elements contained in registers with subword parallelism. Introducing such a mechanism into a SIMD architecture with subword parallelism, such as VMX, did not address the issues noted above, because what is desired is dynamic addressability of individual data elements within vector registers, and not simply dynamic addressability of registers.

More precisely, what is desired is the ability to, ideally using a single instruction, (1) dynamically address, at run time under software control, a number of data elements in arbitrary subword slots in a vector register file, (2) access these data elements and (3) place them in subword slots in a target register in a specified order.

Traditional SIMD architectures with subword parallelism incorporate functions, usually called “permute” or “shuffle”, that provide dynamic addressability of data elements contained within a pair of vector registers. However, the data elements that can be accessed by a single instruction using these mechanisms must be in no more than two registers, and the registers must be specified at compile time. Thus these mechanisms cannot provide the desired capabilities.

Several mechanisms have been reported that potentially or explicitly provide dynamic addressability of registers in a register file, in addition to that employed in eLite as noted above. These include (1) Derby et. al., “VICTORIA: VMX indirect compute technology oriented towards in-line acceleration”, Proceedings of the 3rd conference on Computing frontiers, May 3-5, 2006, (2) U.S. Pat. No. 7,360,063, (3) “Rotating Registers”, Intel Itanium™ Architecture Software Developer's Manual, Part II, 2.7.3, October 2002, (4) Tyson et al., “Evaluating the Use of Register Queues in Software Pipelined Loops”, IEEE Trans. on Computers, vol. 50, No. 8, August 2001, (5) Kiyohara et al., “Register Connection: A New Approach To Adding Registers Into Instruction Set Architectures”, Computer Architecture, 1993., Proceedings of the 20th Annual International Symposium on Computer Architecture, May, 1993 and (6) U.S. Patent Application Publication Number 2003/0191924.

However, these indirect access mechanisms only support dynamic addressability for registers. None of these mechanisms support either explicitly or through obvious extensions, the dynamic addressability of individual data elements in a register file with subword parallelism, and so none can provide the desired capabilities.

Given the current state of the prior art, there is a need to provide dynamic addressability of independent data elements in a register file with subword parallelism, with the ability to access several addressed data elements and place them in subword slots in a target register in a specified order using a single instruction. The essential elements of such a mechanism are: (1) a representation for addresses of data elements stored in a vector register file that is sufficiently flexible to handle all datatypes of interest; (2) a set of “pointer registers”, with each register in the set capable of holding addresses of several independent data elements which are stored in the vector register file; (3) a means for using the addresses in a pointer register to extract the addressed data elements from the registers in which they are located and place them in a specified order in the subword slots of a target register in the VMX register file; and (4) a means for managing the contents of the pointer registers. These features provide dynamic addressability of and simultaneous access to multiple independent subword slots in the vector register file.

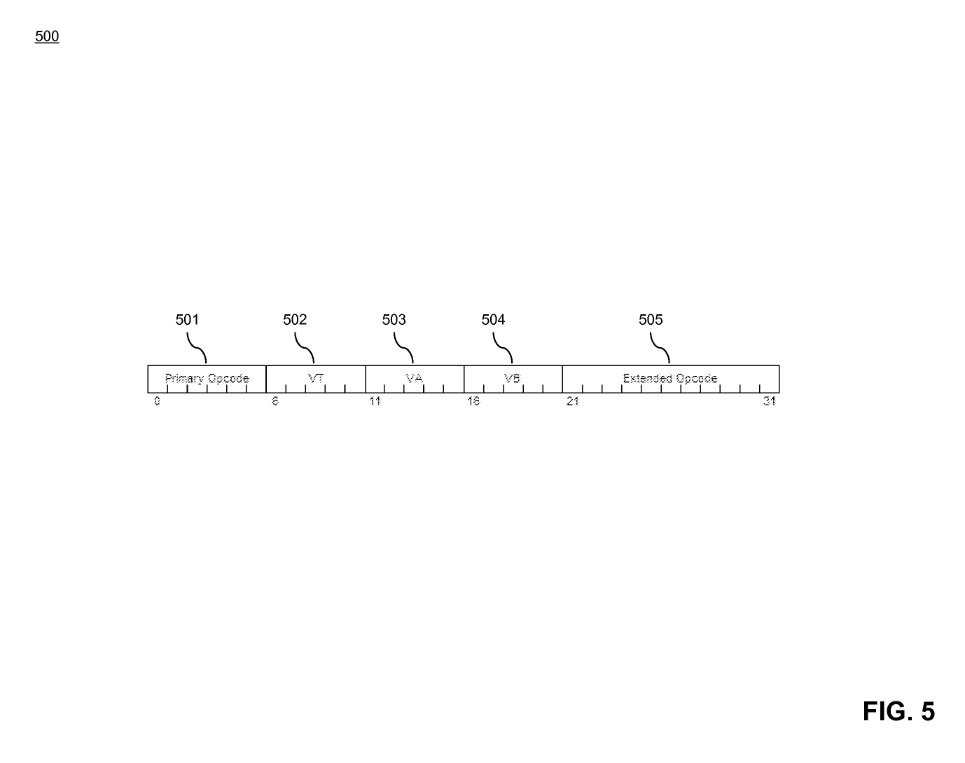

In a preferred embodiment of the present invention, a VMX SIMD architecture is used where each register containing data to be processed (vector register) in the VMX register file (VRF) is partitioned, at least logically, into subword slots, with each subword slot holding a data element. In general, there can be several different partitions possible with different subword-slot sizes, depending on the particular instruction used to process the contents of the vector register. However, all of the subword slots for a given partition of a vector register can preferably be the same size. A typical 32-bit VMX instruction is shown in FIG. 5. The contents of the Primary Opcode 501 and the Extended Opcode 505 indicate the operation to be performed. The two input operands, are shown as VA 503 and VB 504. The results of the operation are placed in the target vector register indicated by the contents of the VT 502 field.

It should be noted that there are architectural and implementation issues that must be considered, including: (a) the number of data elements in a vector varies from four to sixteen, depending on the data elements' datatype and (b) the number of registers in the VRF from which data can be read simultaneously is generally limited by the number of read ports on the physical register file implementing the VRF.

In a preferred embodiment of the invention, the a gather instruction's opcode specifies the datatype of the elements being addressed, accessed, and gathered. It should be noted that the opcode could also contain the associated subword-slot size in the target register. Any operation using the entries in a pointer register to address and extract data elements from the VRF can use four of the eight entries in the pointer register and can extract four data elements. By convention, a “gather high” instruction uses the four leftmost entries in the pointer register, while a “gather low” instruction uses the four rightmost entries. The four extracted data elements are placed in the four leftmost subword slots of a vector, with the slot sizes appropriate for the datatype used. Some examples of datatype in this preferred embodiment are double word, word, halfword and byte.

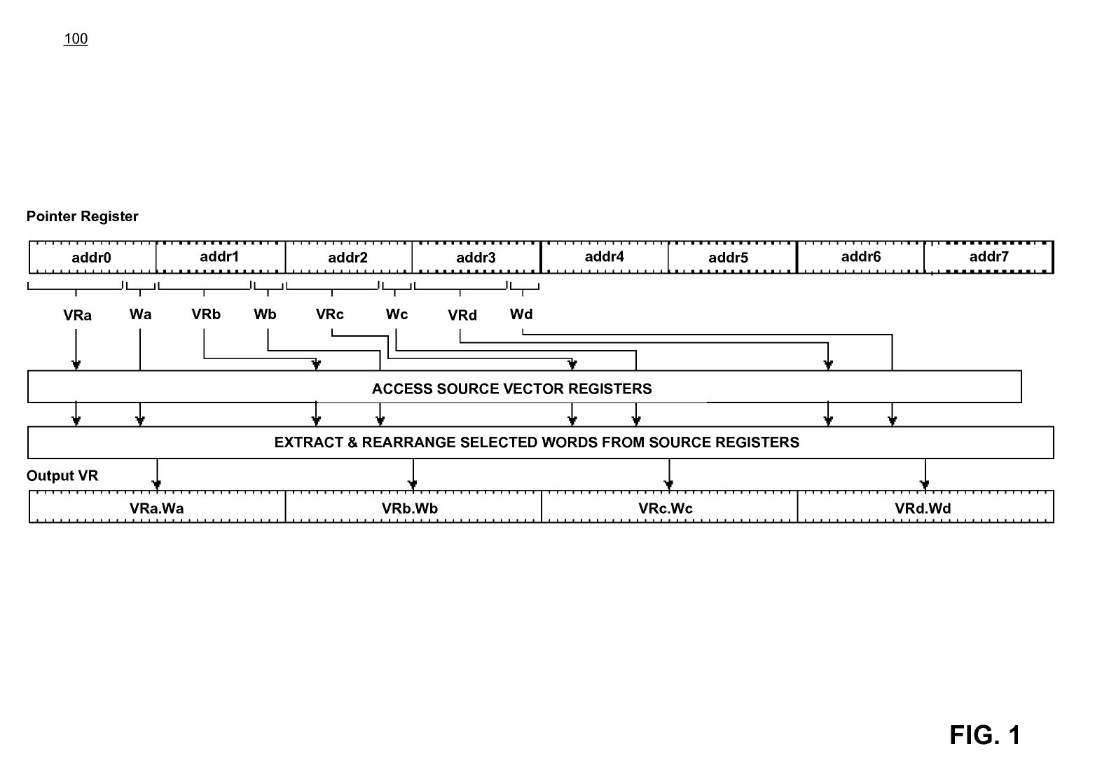

As an example, consider a “gather fullwords high” instruction run on a 128-bit pointer register partitioned into eight 16-bit subword slots shown schematically in FIG. 1. The instruction uses the pointers in the four leftmost halfword slots in the pointer register referenced, namely addr0 to addr3. The four pointer values, stored as byte offsets from the origin of the register file, are parsed into VRa and Wa as shown. The high-order 12 bits (VRa) contain the number of bytes counting from the origin of the VRF, that the index of the register in the VRF containing the word to be accessed is located. The low-order 4 bits contain the number of bytes counting from the beginning of the register in which the word to be accessed in the register is located. The four addressed registers are then accessed via read ports on the VRF. The desired words are extracted and shifted into the proper subword slots, with the shift amount based on the position of the word in the register from which it is taken and the desired position of the word in the target register, which in turn is based on the location of the associated pointer in the pointer register being used.

Operation of a “gather fullwords low” instruction will look just like that shown for the “gather fullwords high” instruction, except that the pointers are taken from the rightmost halfwords in the referenced pointer register, i.e. the fields ‘addr4’, ‘addr5’, ‘addr6’, and ‘addr7’ in FIG. 1. In this case, the word placed in the leftmost slot in the target register is that pointed to by ‘addr4’, the word in the next slot to the right is that pointed to by ‘addr5’.

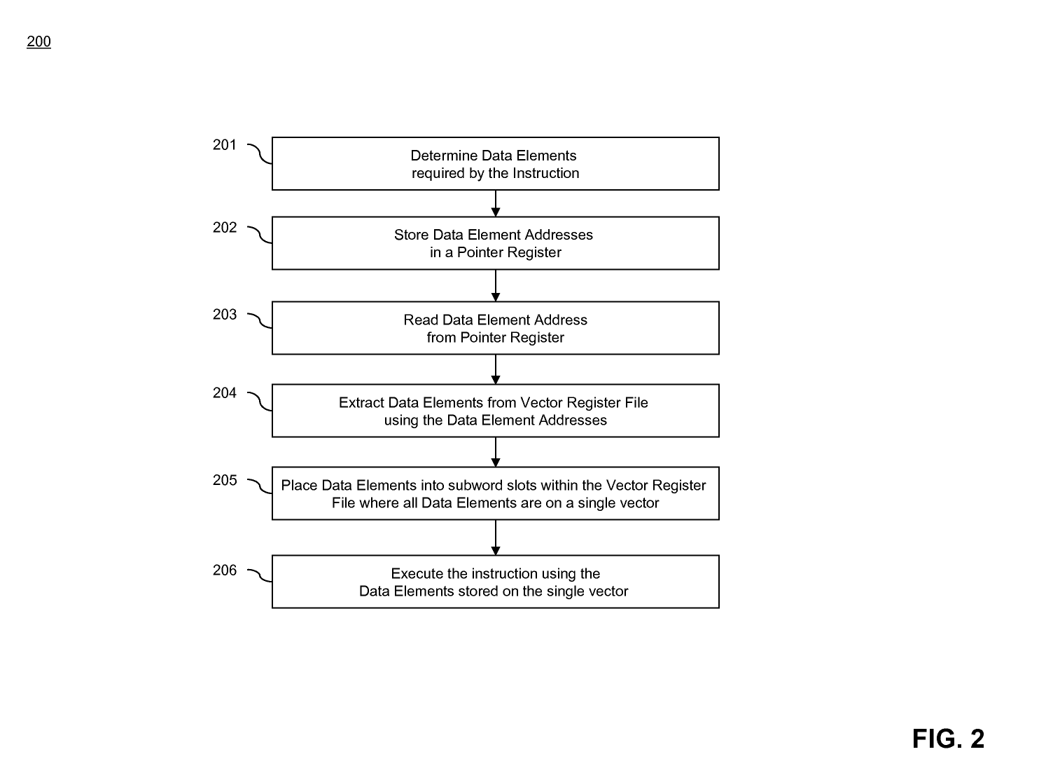

FIG. 2 is a flow chart illustrating a method 200 of providing dynamic addressability of data elements in a vector register file with subword parallelism according to a preferred embodiment of the present invention. At step 201, an instruction is decoded in order to determine which data elements are required by the instruction. The instruction could also contain the length of the data element required by the instruction. For example, a typical “gather high fullwords” will usually gather 32-bits of data which is the default size of a fullword. However, the “gather high fullwords” instruction can also state that the data element is only 24-bits long, instead of the default length of 32-bits, in which case, the gather instruction will only gather 24-bits of data, instead of the default 32-bits of data.

An instruction is a single operation of a processor defined by an instruction set architecture. In a broader sense, an “instruction” can be any representation of an element of an executable program, such as a bytecode. On traditional architectures, an instruction includes an opcode specifying the operation to be performed, such as “add contents of memory to register”, and zero or more operand specifiers, which can specify registers, memory locations, or literal data. The operand specifiers can have addressing modes determining their meaning or can be in fixed fields. Further, a data element is at least a portion of anything that suitable for use with a computer that is not program code.

Once the required data elements are known, the data element's addresses are stored in the same order within a pointer register in step 202 as the order of execution within the instruction. In other words, if an instruction is processing data element A first and data element B second, the addresses of data elements A and B are stored in the same order within the pointer register. In a preferred embodiment of the present invention, the pointer registers are structured to like VMX registers. In other words, the 128-bit registers each use subword partitioning to hold multiple addresses in parallel. In addition, the contents of pointer registers are managed on a SIMD basis in the same way that the contents of the map registers in iVMX are managed. More specifically, addresses which are created in the VMX register are moved, using the computational facilities of VMX, to a pointer register, by incrementing all entries or a subset of the entries in a pointer register by a pre-specified amount, or by initializing the entries in a pointer register based on the value encoded in an immediate field in an instruction. In addition, the vector register file holding the data to be processed can contain up to 4096 128-bit registers, as with iVMX architectures.

In the preferred embodiment of the invention, since subword parallelism has support for data elements ranging in size from one to four, and possibly eight bytes, the address of a data element in the VRF is its byte-offset from the origin of the VRF (the leftmost bit of the register with index 0 in the VRF). The largest available VRF holds 64 KBytes, so 16 bits of memory will store an address of a data element within a VRF. Therefore, eight addresses can be held in a 128-bit pointer register.

In another preferred embodiment of the invention, it can be desirable to employ a finer granularity of addressability, with addresses defined to be bit-offsets (as opposed to byte-offsets) from the origin of the VRF. In this case, 19 bits of memory can be needed to store an address of a data element within a VRF. In order to be consistent with the subword partitioning available for VMX registers, four 32-bit fields can be used to store 4 data element addresses in a 128-bit pointer register.

In step 203, the entries in the pointer register are read to determine the addresses of the data elements used by the instruction. In step 204, the data elements are extracted from the VRF using the addresses read in step 203.

In a preferred embodiment of the invention, in step 205, the data elements are shifted into the proper subword slots in the VRF, with the shift amount based on the position of the data element in the register from which it is taken and the desired position of the data element in the target register, which in turn is based on the location of the associated pointer in the pointer register being used. This allows the processor to execute the instruction with using a single vector containing all of the data elements required by the instruction in step 206.

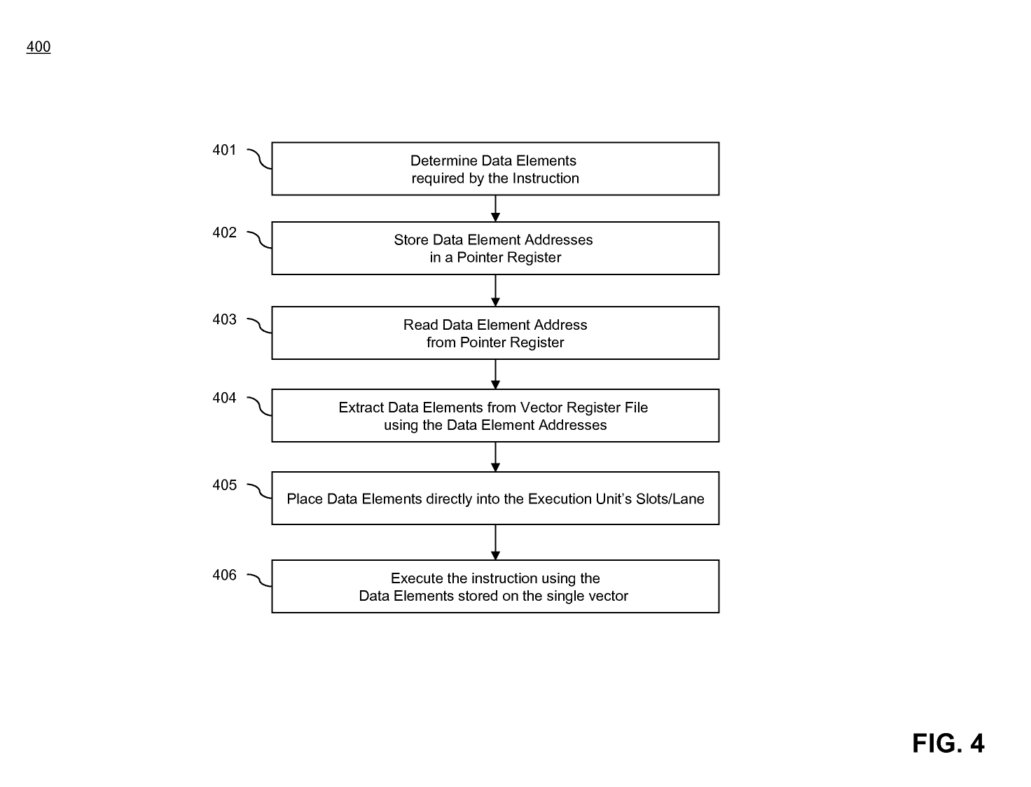

FIG. 4 is a flow chart illustrating another method 400 of providing dynamic addressability of data elements in a vector register file with subword parallelism according to a preferred embodiment of the present invention. At step 401, an instruction is decoded in order to determine which data elements are required by the instruction. The instruction could also contain the length of the data element required by the instruction. For example, a typical “gather high fullwords” will usually gather 32-bits of data which is the default size of a fullword. However, the “gather high fullwords” instruction can also state that the data element is only 24-bits long, instead of the default length of 32-bits, in which case, the gather instruction will only gather 24-bits of data, instead of the default 32-bits of data.

Once the required data elements are known, the data element's addresses are stored in the same order within a pointer register in step 402 as the order of execution within the instruction.

In step 403, the entries in the pointer register are read to determine the addresses of the data elements used by the instruction. In step 404, the data elements are extracted from the VRF using the addresses read in step 403.

In step 405, the data elements are placed directly into the execution unit's slots or lane as opposed to storing the gathered data elements back into the VFR to be then accessed by the execution unit. This allows the processor to execute the instruction with using a single vector containing all of the data elements required by the instruction in step 406.

Two types of operations can use this method: (a) an operation that gathers the desired data elements and places them in a target register in the VRF and (b) an operation that gathers the desired data elements into a vector that is used as the input to a processing step (i.e. that performs an operation on the resulting vector).

In the preferred embodiment of the invention, a “gather” instruction has a pointer register as an input operand and a VRF register as a target operand. The instruction extracts, from the VRF, the data elements addressed by the entries in the pointer register and places them in the target register in the VRF in the order in which their addresses occur in the pointer register.

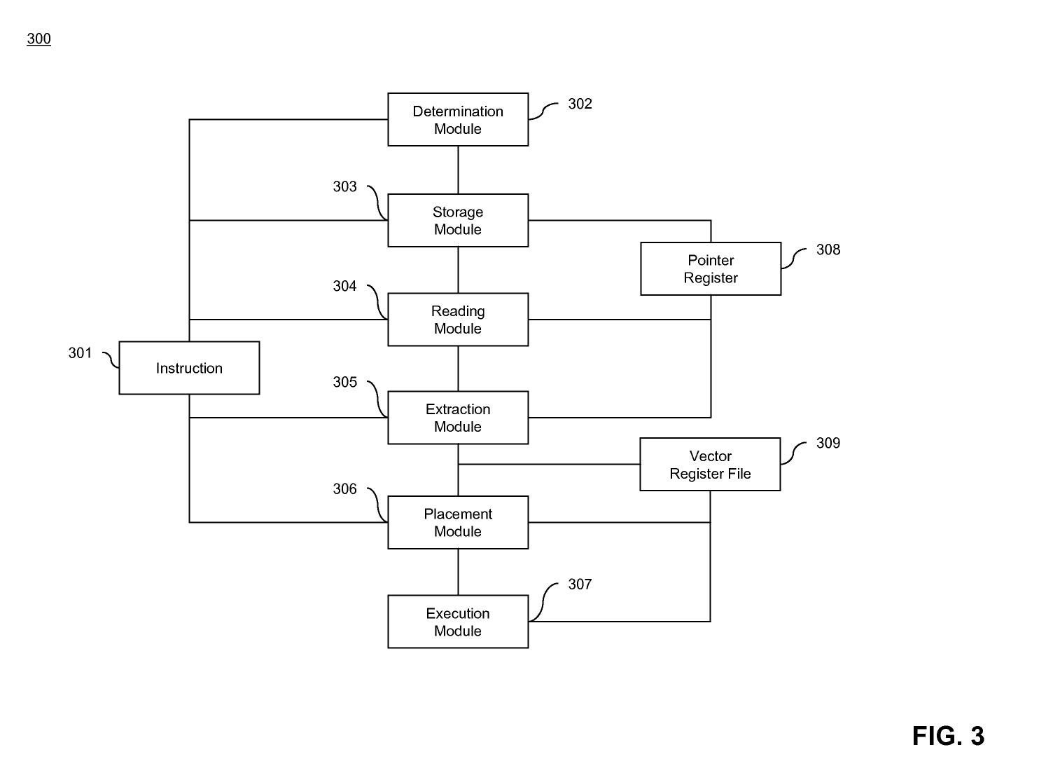

FIG. 3 shows a system for providing dynamic addressability of data elements in a vector register file with subword parallelism according to a preferred embodiment of the present invention. The system 300 includes a determination module 302 which decodes an instruction 301 in order to determine which data elements are required by that instruction.

In the preferred embodiment shown in FIG. 3, system 300 also includes a storage module 303 which stores data element addresses in the same order within a pointer register 308 as the order of execution within the instruction. In other words, if an instruction is processing data element A first and data element B second, the addresses of data elements A and B are stored in the same order within the pointer register. The storage module moves the addresses which are created in the VMX register using the computational facilities of VMX, to a pointer register 308, by incrementing all entries or a subset of the entries in a pointer register 308 by a pre-specified amount, or by initializing the entries in a pointer register 308 based on the value encoded in an immediate field in an instruction 301. The address of a data element in the VRF 309 can be its byte-offset from the origin of the VRF 309 (the leftmost bit of the register with index 0 in the VRF). It can be desirable to employ a finer granularity of addressability, with addresses defined to be bit-offsets (as opposed to byte-offsets) from the origin of the VRF 309.

In the preferred embodiment shown in FIG. 3, system 300 also includes a reading module 304 which reads entries in the pointer register 308 via read ports on the VRF 309 in order to determine where the data elements are located within the VRF 308. Once the addresses are known, the extraction module 305 extracts the data elements from the VRF 309 using the addresses read by the reading module 304.

In the preferred embodiment shown in FIG. 3, system 300 also includes a placement module 306 which shifts the data elements into the proper subword slots in the VRF 309, with the shift amount based on the position of the data element in the register from which it is taken and the desired position of the data element in the target register, which in turn is based on the location of the associated pointer in the pointer register being used.

In the preferred embodiment shown in FIG. 3, system 300 also includes an execution module 307 which executes the instruction 301 using a single vector contained within the VRF 309. The single vector contains all of the data elements required by the instruction 301.

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

The corresponding structures, materials, acts, and equivalents of all means or step plus function elements in the claims below are intended to include any structure, material, or act for performing the function in combination with other claimed elements as specifically claimed. The description of the present invention has been presented for purposes of illustration and description, but is not intended to be exhaustive or limited to the invention in the form disclosed. Many modifications and variations will be apparent to those of ordinary skill in the art without departing from the scope and spirit of the invention. The embodiment was chosen and described in order to best explain the principles of the invention and the practical application, and to enable others of ordinary skill in the art to understand the invention for various embodiments with various modifications as are suited to the particular use contemplated.

1. A method of providing dynamic addressability of data elements in a vector register file with subword parallelism, the method comprising the steps of:
determining a plurality of data elements required for an instruction;
storing an address for each of said plurality of data elements into a pointer register wherein said addresses are stored as a number of offsets from said vector register file's origin;
reading said addresses from said pointer register;
extracting at least one of said plurality of data elements located at said addresses from said vector register file; and
placing at least one of said plurality of data elements onto a single vector;
wherein at least one of the steps is carried out using a computer device so that data elements in a vector register file with subword parallelism are dynamically addressable.

2. The method according to claim 1 wherein said storing an address step comprises the step of:
incrementing said pointer register's entry by a predetermined amount.

3. The method according to claim 1 wherein said storing an address step comprises the step of:
initializing said pointer register's entry based on said instruction's immediate field.

4. The method according to claim 1 wherein said number of offsets is a number of byte offsets from said vector register file's origin.

5. The method according to claim 1 wherein said number of offsets is a number of bit offsets from said vector register file's origin.

6. The method according to claim 1 wherein said instruction's opcode specifies a datatype of the elements.

7. The method according to claim 1 wherein said instruction's opcode specifies an associated subword-slot size in said vector register file.

8. The method according to claim 1 wherein said placing step comprises the step of:
shifting said elements in said vector register file by an amount,
wherein said amount is based on an original position and a desired position of said elements in said vector register file, and said desired position is based on said address.

9. The method according to claim 1 wherein said placing step comprises the step of:
placing said elements into a slot of an execution unit.

10. The method according to claim 1 wherein said vector register file's registers are logically partitioned into subword slots, with each subword slot holding at least one of said plurality of data elements.

11. The method according to claim 1 wherein said placing step comprises the step of:
shifting at least one of said plurality of data elements to a desired location within said vector register file.

12. A system for providing dynamic addressability of data elements in a vector register file with subword parallelism, the system comprising:
a determination module, wherein said determination module is adapted to determine a plurality of data elements required by an instruction;
a storage module, wherein said storage module is adapted to store addresses for each of said plurality of data elements into a pointer register wherein said addresses are stored as a number of offsets from said vector register file's origin;
a reading module, wherein said reading module is adapted to reading said addresses from said pointer register;
an extraction module, wherein said extraction module is adapted to extract at least one of said plurality of data elements located at said addresses from said vector register file;
a placement module, wherein said placement module is adapted to place at least one of said plurality of data elements onto a single vector; and
an execution module, wherein said execution module is adapted to execute said instruction.

13. The system according to claim 12, wherein said storing module stores said address by incrementing said pointer register's entry by a predetermined amount.

14. The system according to claim 12, wherein said storing module stores said address by initializing said pointer register's entry based on said instruction's immediate field.

15. The system according to claim 12 wherein said number of offsets is a number of byte offsets from said vector register file's origin.

16. The system according to claim 12 wherein said number of offsets is a number of bit offsets from said vector register file's origin.

17. The system according to claim 12 wherein said placement module is further adapted to:
place at least one of said plurality of data elements in a subword slot of said vector register file,
wherein said plurality of data elements are located onto a single vector within said vector register file.

18. The system according to claim 12 wherein said placement module is further adapted to:
place said elements into a slot of said execution module.

19. The system according to claim 12 wherein said number of offsets is in binary format.

20. The system according to claim 12 wherein said vector register file's registers are logically partitioned into subword slots, with each subword slot holding at least one of said plurality of data elements.
